(19) United States
(12) Patent Application Publication
(10) Pub. No.: US 2011/0279856 A1
(43) Pub. Date: Nov. 17, 2011

(54) INFORMATION PROCESSING APPARATUS, COOPERATIVE FUNCTION SETTING CONTROL METHOD, AND STORAGE MEDIUM

(75) Inventor: Daisuke Yamazaki, Kawasaki-shi (JP)

(73) Assignee: CANON KABUSHIKI KAISHA, Tokyo (JP)

(21) Appl. No.: 13/101,541

(22) Filed: May 5, 2011

(30) Foreign Application Priority Data
May 12, 2010 (JP) 2010-110508

(51) Int. Cl. G06F 15/16; G06K 15/02

(52) U.S. Cl. 358/1.15; 709/205

(57) ABSTRACT

An information processing apparatus includes an application capable of providing a plurality of types of cooperative functions in cooperation with a multi functional peripheral. The information processing apparatus additionally includes a setting unit, a determination unit, an indicating unit. The setting unit performs setting as a setting processing for each cooperative function in response to a user operation via the application. The determination unit confirms if there is at least one cooperative function that is not yet set by the setting unit and is different from the cooperative function subjected to the setting processing, among the plurality of types of cooperative functions, when the setting unit performs setting for one cooperative function, and, if the at least one cooperative function is confirmed, further determines whether the at least one cooperative function is usable via the application. The indicating unit indicates a usable cooperative function determined by the determination unit.

### BACKGROUND OF THE INVENTION

1. Field of the Invention

The present invention relates to an information processing apparatus, a cooperative function setting control method, and a storage medium.

2. Description of the Related Art

Recent digital multi functional peripherals (MFP) have been functionally operable as a printer, a facsimile machine, a scanner, and a file server. The digital multi functional peripheral is generally connected to an information processing apparatus (a client) via a network and can perform various operations in cooperation with the information processing apparatus. In other words, the digital multi functional peripheral and the information processing apparatus can realize cooperative functions.

An example of the cooperative functions that can be realized by the digital multi functional peripheral and the information processing apparatus is a function enabling users to store a document scanned by the digital multi functional peripheral into a storage destination of the information processing apparatus. Another example of the cooperative functions is a function enabling a user of the information processing apparatus to browse and edit a document stored in the digital multi functional peripheral.

A condition required to realize a cooperative function based on cooperation between the digital multi functional peripheral and the information processing apparatus is that each of the digital multi functional peripheral and the information processing apparatus is in a usable state.

As discussed in Japanese Patent Application Laid-Open No. 2006-115222, when a user of an image processing apparatus uses a cooperative function to be performed in cooperation with an information processing apparatus, a conventional method can determine whether the cooperative function is usable and indicate a state of the usable cooperative function.

In this case, an intended cooperative function may require completing settings before starting an operation using the cooperative function. Similarly, in a case where available two or more cooperative functions are different from each other, it may be required to complete settings beforehand for each of the functions. Accordingly, it is not easy for a user to indentify a cooperative function that requires preliminary settings before using it, when a plurality of cooperative functions is available. As a result, a relatively long time is required to complete cooperative function settings.

### SUMMARY OF THE INVENTION

According to an aspect of the present invention, an information processing apparatus includes an application capable of providing a plurality of types of cooperative functions in cooperation with a multi functional peripheral. The information processing apparatus includes a setting unit configured to perform setting as a setting processing for each cooperative function of the plurality of types of cooperative functions in response to a user operation via the application; a determination unit configured to confirm if there is at least one cooperative function that is not yet set by the setting unit and is different from the cooperative function subjected to the setting processing, among the plurality of types of cooperative functions, when the setting unit performs setting for one cooperative function, and, if the at least one cooperative function is confirmed, further configured to determine whether the at least one cooperative function is usable via the application; and an indicating unit configured to indicate a usable cooperative function determined by the determination unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of a cooperative function setting control system according to an exemplary embodiment.

FIG. 2 illustrates an example of a hardware configuration of an information processing apparatus according to an exemplary embodiment.

FIG. 3 illustrates an example of a hardware configuration of a digital multi functional peripheral according to an exemplary embodiment.

FIG. 4 illustrates an example of a functional configuration of an application that can be installed on the information processing apparatus according to an exemplary embodiment.

FIG. 5 illustrates an example of a graphic user interface (GUI) that can be provided by the application according to an exemplary embodiment.

FIG. 6 illustrates an example of a functional configuration of the digital multi functional peripheral according to an exemplary embodiment.

FIG. 7 includes FIG. 7A, and FIG. 7B, each of which are flowcharts illustrating an example of miscellaneous cooperative function determination processing according to an exemplary embodiment.

FIG. 8 includes FIG. 8A, and FIG. 8B, each of which are flowcharts illustrating an example of registrability determination processing according to an exemplary embodiment.

FIG. 9 is a flowchart illustrating an example of registrability determination processing according to an exemplary embodiment.

FIG. 10 is a flowchart illustrating an example of registrability determination processing according to an exemplary embodiment.

FIG. 11 is a flowchart illustrating an example of indication processing according to an exemplary embodiment.

FIG. 12 illustrates an example of a miscellaneous cooperative function display screen according to an exemplary embodiment.

### DESCRIPTION OF THE EMBODIMENTS

Various exemplary embodiments, features, and aspects of the invention will be described in detail below with reference to the drawings.

<System Configuration>

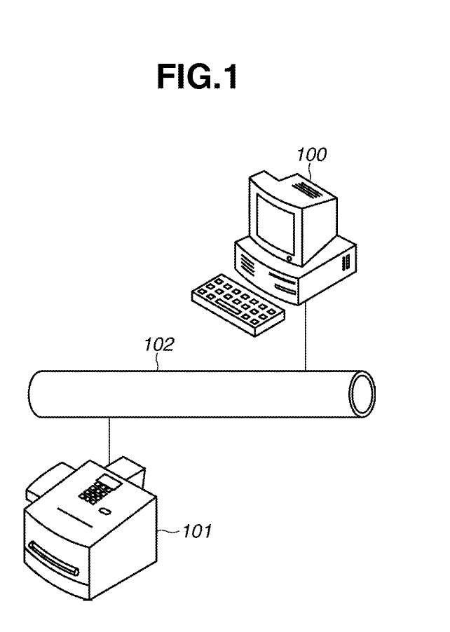

FIG. 1 illustrates an example of a configuration of a cooperative function setting control system according to a present exemplary embodiment. The cooperative function setting control system includes an information processing apparatus 100 and a digital multi functional peripheral 101. The information processing apparatus 100 can communicate with the digital multi functional peripheral 101 via a network 102.

The information processing apparatus 100 and the digital multi functional peripheral 101 can provide various cooperative functions. The information processing apparatus 100 is an example of a computer. The digital multi functional peripheral 101 is an example of a multi functional peripheral, which is functionally operable as a copy machine, a scanner, a printer, and a facsimile machine. In addition, the digital multi functional peripheral 101 has a file transmission function and a Box function.

The information processing apparatus 100 performs various operations according to a predetermined operating system (OS) installed thereon. A printer driver, installed on the OS, enables users to instruct printing or fax transmission to an output apparatus, such as an image forming apparatus or the digital multi functional peripheral 101. The information processing apparatus 100 can instruct, via the printer driver, the output apparatus to perform printing and fax transmission of various files.

Further, an application capable of providing a plurality of types of cooperative functions is installed on the information processing apparatus 100. The application includes a facsimile work improving function, an information integration managing function, and a print cost reducing function. The application further includes a paperless work promoting function, an electronic document based approving function, and an in-house information sharing function.

The application according to the present exemplary embodiment enables users to register a printer icon, a scan transmission button, and a Box function to realize cooperative functions. When the printer icon is registered to realize one of the cooperative functions (an example of a job control cooperative function), users of the information processing apparatus 100 can instruct the digital multi functional peripheral 101 to perform printing via the printer icon registered in the digital multi functional peripheral 101.

Further, users of the information processing apparatus 100 can instruct the digital multi functional peripheral 101 to perform fax transmission via a fax icon registered in the digital multi functional peripheral 101 based on registration of the printer icon to realize one of the cooperative functions (an example of the job control cooperative function).

The job control cooperative function according to the present exemplary embodiment enables users to causes a multi functional peripheral to execute a job by transmitting job control information that instructs the multi functional peripheral to execute the job.

Further, when the scan transmission button is registered, the scan transmission button (an example of a transmission unit) is registered on a graphic user interface (GUI) of the digital multi functional peripheral 101 and enables users to transmit image data (image information) scanned by the digital multi functional peripheral 101.

More specifically, an example of a scan cooperative function (one of the cooperative functions) enabling users to transmit image data scanned by the digital multi functional peripheral 101 to the information processing apparatus 100 via the registered scan transmission button can be realized.

Further, when the Box function is registered to realize an example of an operational cooperative function (one of the cooperative functions), users of the information processing apparatus 100 can browse and operate folders and files stored in the digital multi functional peripheral 101.

For example, to realize the above-described cooperative functions, users can designate an intended document, with a drag and drop operation or a pressing operation, in connection with an object (e.g., an object having a role of launching the job control cooperative function) disposed as an icon on the GUI of the application.

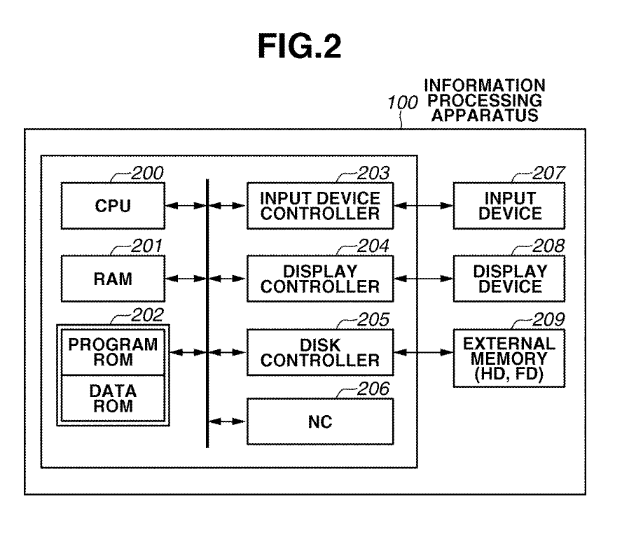

FIG. 2 illustrates an example of a hardware configuration of the information processing apparatus 100. The hardware configuration of the information processing apparatus 100 corresponds to a hardware configuration of a general information processing apparatus. The hardware configuration of the general information processing apparatus is applicable to the information processing apparatus 100.

The information processing apparatus 100 includes a central processing unit (CPU) 200 that can execute the OS or a program (e.g., an application) loaded into a random access memory (RAM) 201 from a program ROM of the ROM 202 or from an external memory 209. Functions of the information processing apparatus 100 and processing of flowcharts described below can be realized by executing the program. The RAM 201 is functionally operable as a main memory or a work area for the CPU 200.

The information processing apparatus 100 further includes an input device controller 203 that can control an input if it is received from an input device 207, such as a keyboard or a mouse. A display controller 204 can control contents to be displayed on a display device 208. A disk controller 205 can control data access in the external memory 209 (e.g., a hard disk (HD) or a flexible disk (FD)) that stores various data. An NC 206 can execute communication control processing when the information processing apparatus 100 communicates with other device connected to the network 102.

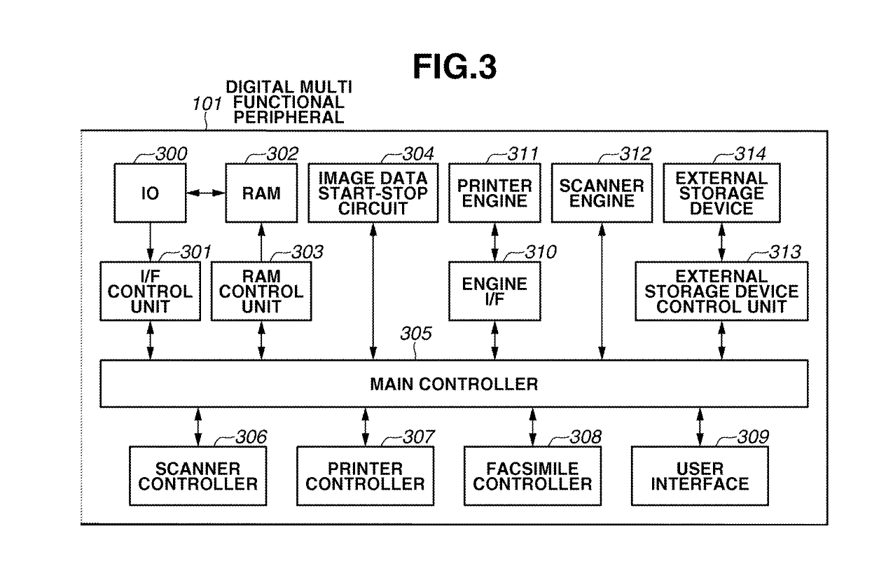

FIG. 3 illustrates an example of a hardware configuration of the digital multi functional peripheral 101. An input/output unit (I/O) 300 is connected to the information processing apparatus 100 via the network 102 (e.g., local area network (LAN) or comparable communication medium). The digital multi functional peripheral 101 may include a plurality of input/output units so that the digital multi functional peripheral 101 can simultaneously communicate with a plurality of devices.

The digital multi functional peripheral 101 can receive and process a print instruction and various control commands from the information processing apparatus 100 via the I/O 300. Further, the digital multi functional peripheral 101 can transmit a scanned image to the information processing apparatus 100 via the I/O 300.

An interface (I/F) control unit 301 can issue a device ID for a processing system, such as a scanner, a printer, and a facsimile machine, installed on the digital multi functional peripheral 101. A random access memory (RAM) 302 is an example of a temporary storage device. The RAM 302 can store external data, such as control commands acquired via the I/O 300, and image data (image information) read by a scanner engine 312. Further, if an image is rasterized by a printer controller 307, the RAM 302 can temporarily store the rasterized image until the rasterized image is sent to a printer engine 311.

A RAM control unit 303 can manage allocation of the RAM 302. An image data start-stop circuit 304 is a device capable of outputting an image in synchronization with a rotation of the printer engine 311 if the image is acquired by the printer controller 307 or the scanner engine 312 and rasterized by the RAM control unit 303. The printer engine 311 is a device capable of developing an image on a recording medium (e.g., a paper).

A main controller 305 can control, via an engine interface (Engine I/F) 310, various operations to be performed by the printer engine 311. Further, the main controller 305 is a principal module that can perform appropriate processing for distributing information (e.g., control languages) received from the information processing apparatus 100 via the I/O 300 to a scanner controller 306, the printer controller 307, or a facsimile controller 308.

Further, the main controller 305 can control the printer engine 311 and the scanner engine 312 in response to an instruction received from any one of respective controllers or the user interface 309.

Using a unified control interface for the main controller 305 and various controllers is useful because an expansion board capable of processing a plurality of types of control commands can be mounted on one peripheral device. Further, the main controller 305 can acquire a device ID of an extended controller, which is presently mounted, from each controller. The main controller 305 can manage the acquired device ID.

If the scanner controller 306 receives a scan control command from the information processing apparatus 100, the scanner controller 306 decomposes the received scan control command into an internal execution command, which can be interpreted by the main controller 305. Further, the scanner controller 306 can change an image read by the scanner engine 312 into a scan control command. The printer controller 307 decomposes a page description language (an example of job control information) received from the information processing apparatus 100 into an internal execution command.

In this case, the internal execution command includes a rasterized image of the page description language, which can be interpreted by the main controller 305. The rasterizing image is sent to the printer engine 311 and output as an image formed on a recording medium (e.g., a paper).

If the facsimile controller 308 receives a fax control language (an example of job control information) from the information processing apparatus 100, the facsimile controller 308 rasterizes the received fax control language into an image and transfers the rasterized image to other facsimile machine via a public circuit or Internet.

The user interface 309 is functionally operable as an input/output unit, which enables a user to input an instruction when the user performs various settings via the main controller 305, or when the user directly uses a scanner function, a printer function, or a fax function of the digital multi functional peripheral 101.

The scanner engine 312 can read a printed image with an optical apparatus in accordance with an instruction received from the main controller 305. The scanner engine 312 converts the read image into an electric signal and sends the electric signal to the main controller 305.

If an external storage device control unit 313 receives an image read by the scanner engine 312, the external storage device control unit 313 converts the received image into image data having a predetermined data format that can be stored in the external storage device 314. If the external storage device 314 receives image data from the external storage device control unit 313, the external storage device 314 stores the received image data.

The digital multi functional peripheral 101 having the above-described configuration can receive a file, for example, via the I/O 300 and store the received data. The printer controller 307 reads stored data and performs print processing based on the readout data.

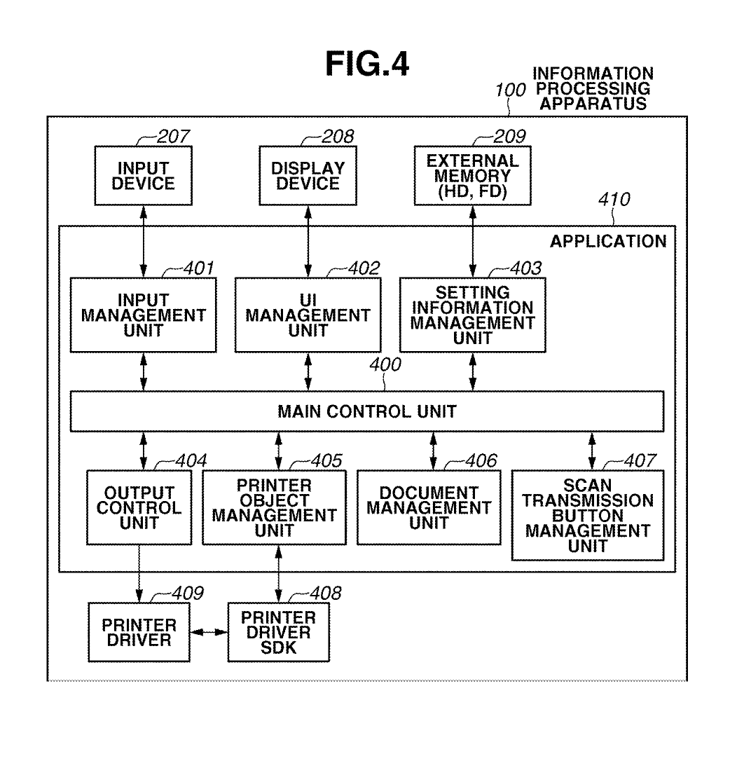

FIG. 4 illustrates an example of a functional configuration of an application 410 that can be installed on the information processing apparatus 100. A main control unit 400 can control an overall operation to be performed by the application 410. Further, the main control unit 400 can perform instruction and management for the following functional units.

The application 410 includes a UI management unit 402 that can display a GUI of the application 410 on the display device 208 according to an instruction received from the main control unit 400.

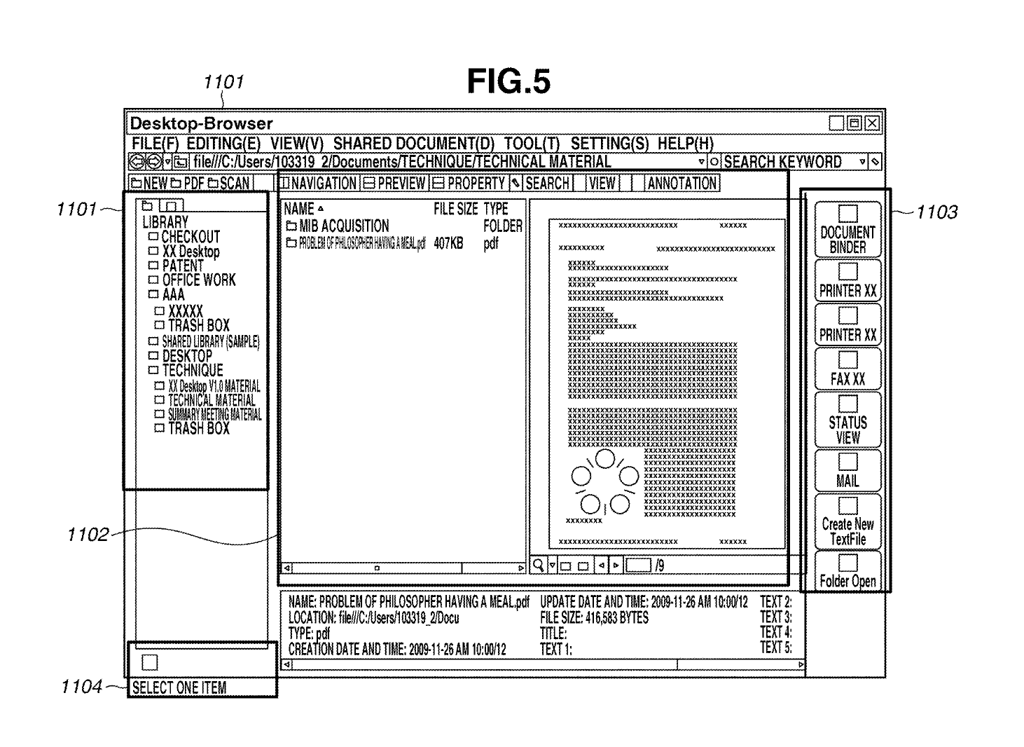

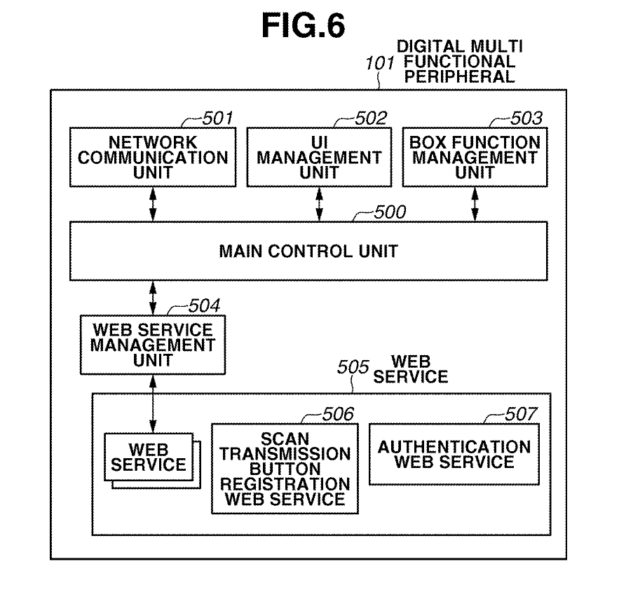

FIG. 5 illustrates an example (a screen 1100) of the GUI that can be provided by the application 410. The screen 1100 includes an area 1101, an area 1102, an area 1103, and an area 1104. The GUI can display, in the area 1101, a tree view of a folder configuration in addition to repository information. The GUI can display, in the area 1102, thumbnails (or icons) each representing document data in addition to a preview of a selected document.

The GUI can display, in the area 1103, an icon that enables users to instruct printing execution and an icon that enables users to display a status of the digital multi functional peripheral 101. The GUI can display, in the area 1104, an icon that enables users to edit setting information relating to the scan transmission button registered in the digital multi functional peripheral 101.

The type (or format), area configuration, and controls of the screen 1100 are not limited to the example illustrated in FIG. 5. Any other appropriate screen is employable if the required functions can be realized.

The application 410 further includes an input management unit 401 that can acquire information entered by a user through an input operation using the input device 207 while viewing the GUI of the application 410 displayed by the UI management unit 402. The input management unit 401 transmits a notification of acquired information to the main control unit 400.

A setting information management unit 403 can manage setting information to be used (held) by the application 410. More specifically, the setting information management unit 403 writes setting information (i.e., information set by a user via the GUI of the application 410) into a setting file stored in the external memory 209 and reads setting information from the setting file.

For example, the UI management unit 402 can receive a print instruction from a user via the GUI of the application 410 (through a pressing operation on the printer icon in the area 1103). In this case, the UI management unit 402 sends information relating to the received print instruction (instruction information) to an output control unit 404.

If the output control unit 404 receives instruction information, the output control unit 404 causes a printer driver 409 corresponding to the instructed printer icon to convert an instructed file into print instruction information (an example of job control information) that can be interpreted by the digital multi functional peripheral 101. Then, the output control unit 404 transmits the converted print instruction information to the digital multi functional peripheral 101 via the network 102.

In the present exemplary embodiment, an output port (not illustrated) having been set to a printer object corresponding to the printer icon may be its own output port of the application 410. In this case, the main control unit 400 acquires status information of the digital multi functional peripheral 101 via the output port. The main control unit 400 sends the acquired status information to the UI management unit 402. The UI management unit 402 displays the status in the area 1103 of the screen 1100 (the application 410).

A printer object management unit 405 can acquire printer object information and printer driver information via the OS or a printer driver SDK 408. Further, the printer object management unit 405 can manage printer objects to be displayed as printer icons by the application 410. In this case, to enable the printer driver 409 and the application 410 to perform a cooperatively operation, an interface (IF) may be opened to enable the application 410 to control a function of the printer driver 409. In the present exemplary embodiment, the connection between the printer driver SDK 408 and the application 410 is assured. The printer driver SDK 408 can control, via the above-described IF, operations to be performed between the application 410 and the printer driver 409.

A document management unit 406 can acquire folder/file information to be displayed in the area 1101 and the area 1102 of the GUI that can be provided by the application 410 from the external memory 209 of the information processing apparatus 100 or via the network. Further, the document management unit 406 can control editing processing performed on an acquired file (or folder).

A scan transmission button management unit 407 can manage scan transmission button setting information that can be edited via an icon disposed in the area 1104 of the application 410. Further, the scan transmission button management unit 407 can control inquiries sent to the digital multi functional peripheral 101, such as an inquiry confirming if a web service required in the registration of the scan transmission button is present and an inquiry to acquire the scan transmission button setting information.

FIG. 6 illustrates an example of a functional configuration of the digital multi functional peripheral 101. A main control unit 500 can control software programs to be executed in the digital multi functional peripheral 101. The main control unit 500 sends instructions to and manages the following functional units. A network communication unit 501 can control various information transmission/reception operations when the digital multi functional peripheral 101 communicates with an external device (e.g., the information processing apparatus 100) via the network 102.

A user interface (UI) management unit 502 can control the user interface 309 to display the GUI of the digital multi functional peripheral 101 and can receive a user instruction entered via the user interface 309. The UI management unit 502 transmits a notification to the main control unit 500 to inform the content of the performed operation. Further, the UI management unit 502 can display the scan transmission button registered by the information processing apparatus 100.

A Box function management unit 503 can perform reading/writing control, via the external storage device control unit 313 of the digital multi functional peripheral 101, to read and write information of various folders and files from and to the external storage device 314.

The digital multi functional peripheral 101 includes a plurality of web services 505, 506, and 507. For example, the web service 506 is a scan transmission button registration web service, which is available to register the scan transmission button on the GUI of the digital multi functional peripheral 101. The authentication web service 507 is an authentication web service, which is available to manage authentication to be performed for the digital multi functional peripheral 101. In the present exemplary embodiment, the number of web services and the type of each web service are not limited to the example described in the present exemplary embodiment.

A web service management unit 504 can manage information (service information) relating to the web services 505 to 507 and can store the service information in a web service registry (not illustrated). Further, the web service management unit 504 can receive a web service registration request and a web service deletion request. In response to the received request, the web service management unit 504 can register or delete a designated web service to or from the web service registry.

Further, the web service management unit 504 can receive a web service search request, via the I/O 300, from the information processing apparatus 100. The web service management unit 504 can return a response (search result) to the information processing apparatus 100. In the present exemplary embodiment, a general web service technique, such as Universal Description, Discovery, and Integration (UDDI), can be employed to realize each web service to be provided by the digital multi functional peripheral 101.

<Miscellaneous Cooperative Function Determination Processing>

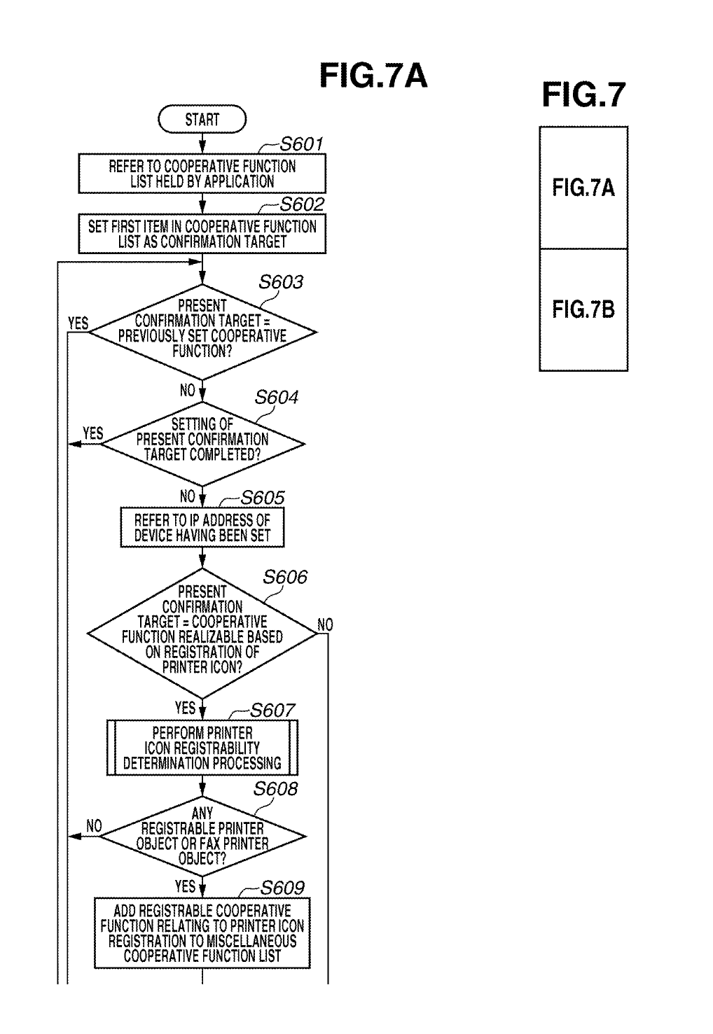

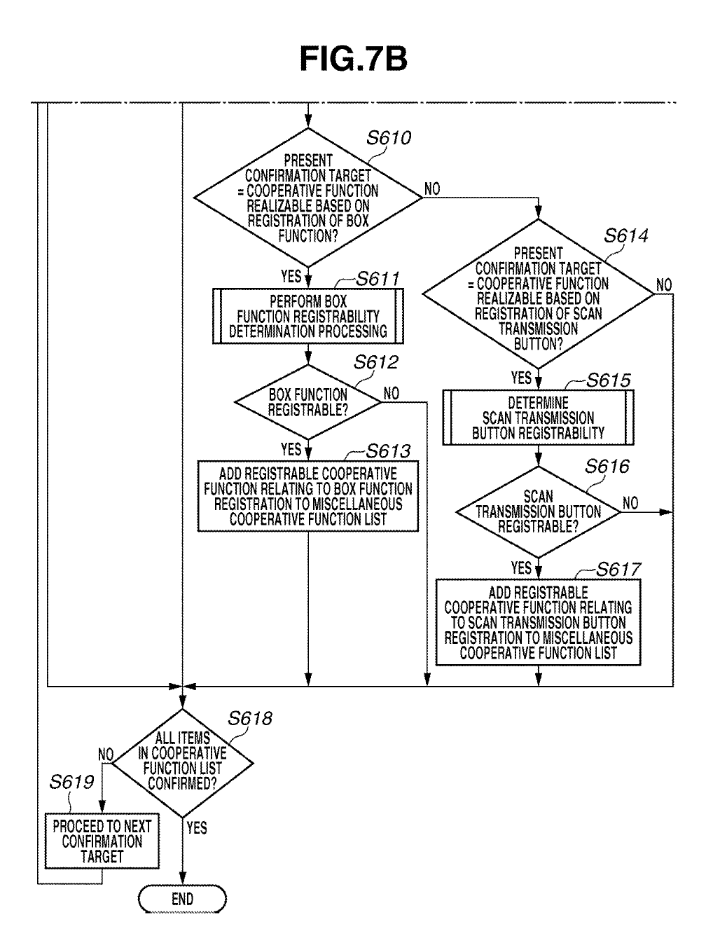

FIG. 7 is a flowchart illustrating an example of miscellaneous cooperative function determination processing, which can be performed by the information processing apparatus 100. In the miscellaneous cooperative function determination processing, when setting is performed for one of cooperative functions to be performed in cooperation with the digital multi functional peripheral 101 provided by the application 410, the information processing apparatus 100 identifies a cooperative function that is not yet subjected to the setting processing and becomes usable if setting is performed. In the present exemplary embodiment, users can perform settings of cooperative functions by operating the input device 207 via the GUI of the application 410 displayed on the display device 208.

To realize sequential processing in step S601 to step S619, the CPU 200 executes programs of the application 410 and the printer driver 409 loaded into the RAM 201 from the ROM 202 or the external memory 209. Further, the miscellaneous cooperative function determination processing starts upon executing setting for any one of the cooperative functions to be performed in cooperation with the digital multi functional peripheral 101, which are provided by the application 410 via the GUI of the application 410.

First, in step S601, if a setting execution request is received, the input management unit 401 transmits a notification to the main control unit 400 to inform the received setting execution request. If the main control unit 400 receives the notification from the input management unit 401, the main control unit 400 causes the setting information management unit 403 to acquire a list of cooperative functions that can be realized in cooperation with the digital multi functional peripheral 101, which is stored in a memory device. In the following description, the list of cooperative functions is referred to as a “cooperative function list.” The main control unit 400 refers to the acquired cooperative function list.

The cooperative function list is an information list that identifies functions that can be provided by the application 410 in cooperation with the digital multi functional peripheral 101. For example, the cooperative function list is stored as a text file in the external memory 209. The setting information management unit 403 reads the text file from the external memory 209.

Subsequently, instep S602, the main control unit 400 sets a cooperative function listed as the first item in the cooperative function list as a target (confirmation target) in the present processing. Subsequently, in step S603, the main control unit 400 determines whether the target cooperative function to be confirmed coincides with a cooperative function having been set before starting the present processing.

In this case, if it is determined that the target cooperative function to be confirmed coincides with the previously set cooperative function (YES in step S603), the main control unit 400 performs processing in step S618. On the other hand, if it is determined that the target cooperative function to be confirmed does not coincide with the previously set cooperative function (NO in step S603), the main control unit 400 performs processing in step S604.

In step S604, the main control unit 400 refers to setting information managed by the setting information management unit 403 and determines whether the target cooperative function to be confirmed has been already set. The setting information is a text file stored in the external memory 209. If setting is performed, the setting information management unit 403 writes setting contents in the external memory 209. Further, when the application 410 is launched, the setting information management unit 403 reads the setting contents from the external memory 209.

In this case, if it is determined that the target cooperative function to be confirmed has been already set (YES in step S604), the main control unit 400 performs processing in step S618. On the other hand, if it is determined that the target cooperative function to be confirmed has not yet been set (NO in step S604), the main control unit 400 performs processing in step S605.

In step S605, the main control unit 400 refers to an IP address of the digital multi functional peripheral 101 (an example of identification information that can identify the multi functional peripheral), which is included in the setting information having been set before starting the present processing. The main control unit 400 causes the setting information management unit 403 to temporarily store the IP address of the digital multi functional peripheral 101 in the program.

Subsequently, instep S606, the main control unit 400 determines whether the target cooperative function to be confirmed is a cooperative function that can be realized based on registration of the printer icon. In this case, if it is determined that the target cooperative function to be confirmed is a cooperative function realizable based on registration of the printer icon (YES in step S606), the main control unit 400 performs processing in step S607.

On the other hand, if it is determined that the target cooperative function to be confirmed is not a cooperative function realizable based on registration of the printer icon (NO in step S606), the main control unit 400 performs processing in step S610.

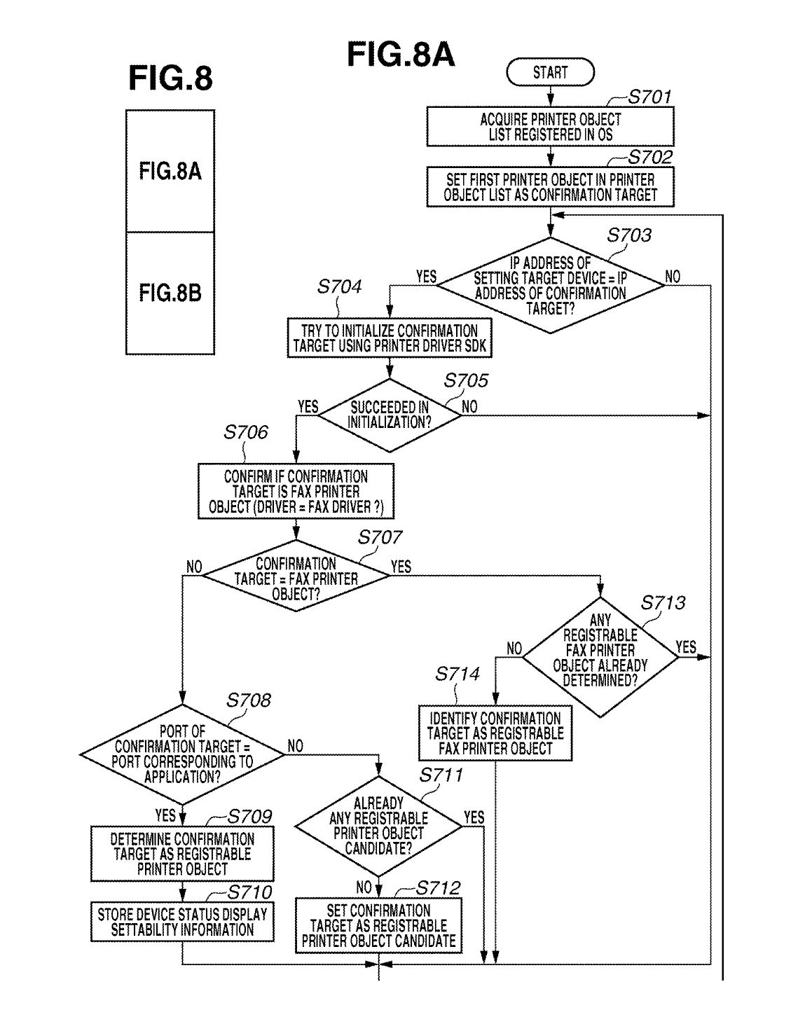

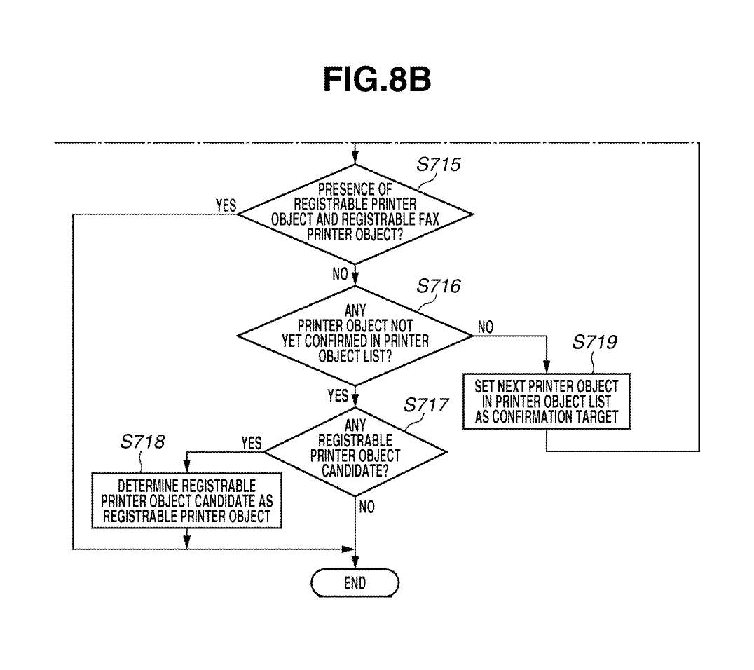

In step S607, the main control unit 400 performs printer icon registrability determination processing (see FIG. 8) to confirm if a printer object or a fax printer object (fax object) corresponding to a setting target digital multi functional peripheral 101 is present. Subsequently, if it is determined that a registrable printer object (or fax printer object) is present (YES in step S608), then in step S609, the main control unit 400 adds a registrable cooperative function relating to the registration of the printer icon to a miscellaneous cooperative function list.

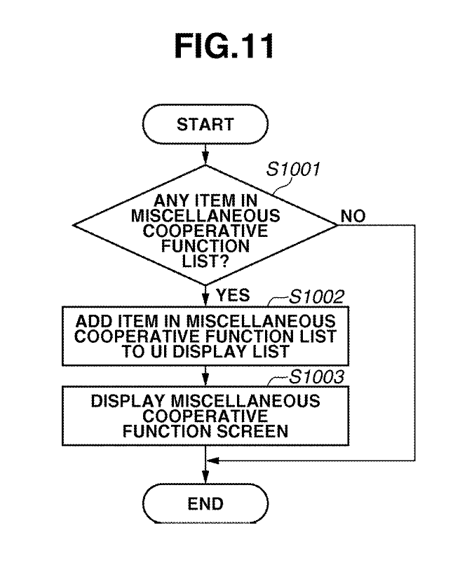

Subsequently, the main control unit 400 performs processing in step S618. The miscellaneous cooperative function list is a list temporarily held by the setting information management unit 403, which indicates usable cooperative functions other than the cooperative functions having been already set before starting the present processing. For example, the miscellaneous cooperative function list is usable in the indication processing illustrated in FIG. 11. On the other hand, if it is determined that a registrable printer object (or fax printer object) is not present (NO in step S608), the main control unit 400 performs processing in step S618.

In step S610, the main control unit 400 determines whether the target cooperative function to be confirmed is a cooperative function that can be realized based on registration of the Box function. In this case, if it is determined that the target cooperative function to be confirmed is a cooperative function realizable based on registration of the Box function (YES in step S610), the main control unit 400 performs processing in step S611.

On the other hand, if it is determined that the target cooperative function to be confirmed is not a cooperative function realizable based on registration of the Box function (NO in step S610), the main control unit 400 performs processing in step S614.

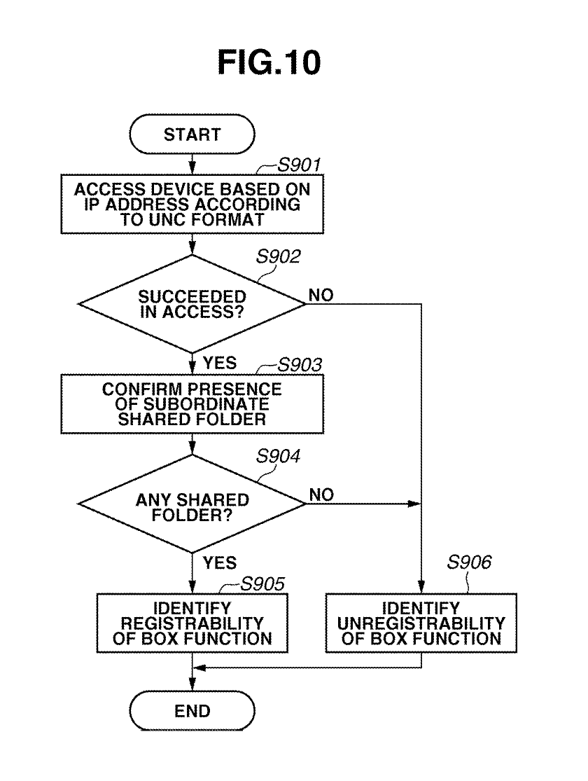

In step S611, the main control unit 400 performs Box function registrability determination processing (see FIG. 10) to confirm if the Box function is usable in the setting target digital multi functional peripheral 101. Subsequently, if it is determined that the Box function is usable (YES in step S612), then in step S613, the main control unit 400 adds a cooperative function relating to the registration of the Box function to the miscellaneous cooperative function list. Subsequently, the main control unit 400 performs processing in step S618. On the other hand, if it is determined that the Box function is not usable (NO in step S612), the main control unit 400 performs processing in step S618.

In step S614, the main control unit 400 determines whether the target cooperative function to be confirmed is a cooperative function that can be realized based on registration of the scan transmission button. In this case, if it is determined that the target cooperative function to be confirmed is a cooperative function realizable based on registration of the scan transmission button (YES in step S614), the main control unit 400 performs processing in step S615.

On the other hand, if it is determined that the target cooperative function to be confirmed is not a cooperative function realizable based on registration of the scan transmission button (NO in step S614), the main control unit 400 performs processing in step S618.

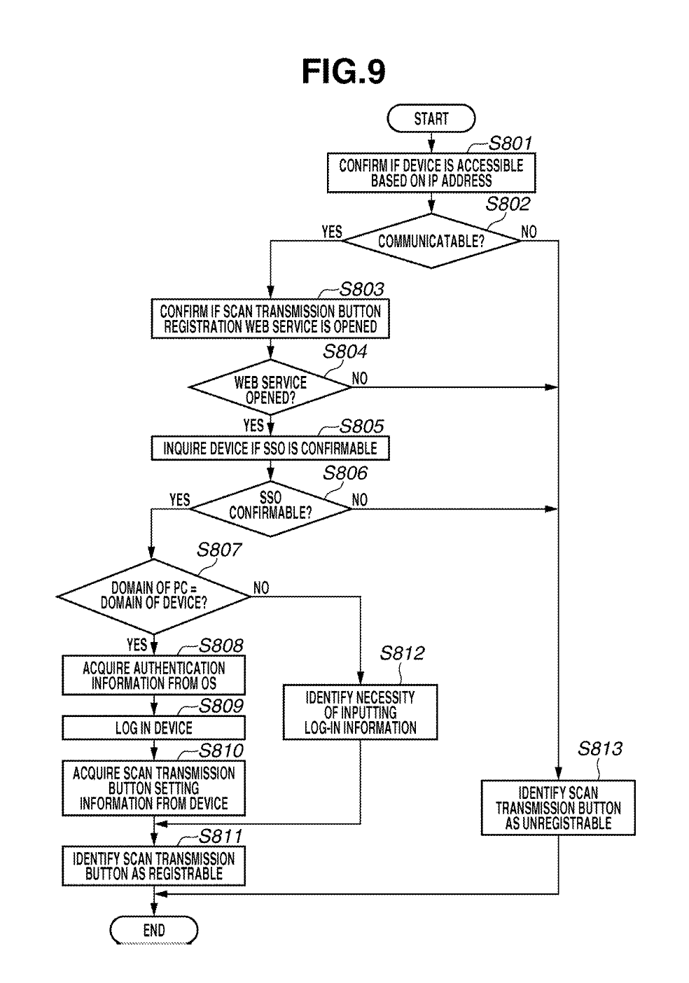

In step S615, the main control unit 400 performs scan transmission button registrability determination processing (see FIG. 9) to confirm if the information processing apparatus 100 can cause the setting target digital multi functional peripheral 101 to register the scan transmission button. Subsequently, if it is determined that the scan transmission button is registrable (YES in step S616), then in step S617, the main control unit 400 adds a cooperative function relating to the registration of the scan transmission button to the miscellaneous cooperative function list. Subsequently, the main control unit 400 performs processing in step S618.

On the other hand, if it is determined that the scan transmission button is not registrable (NO in step S616), the main control unit 400 performs processing in step S618.

In step S618, the main control unit 400 determines whether the cooperative functions in the cooperative function list relating to the digital multi functional peripheral 101 have been thoroughly confirmed. If it is determined that a non-confirmed cooperative function is present (NO in step S618), then in step S619, the main control unit 400 sets the next cooperative function in the cooperative function list as a new confirmation target and restarts the processing in step S603. On the other hand, if it is determined that the cooperative functions in the cooperative function list have been thoroughly confirmed (YES in step S618), the main control unit 400 terminates the processing of the flowchart illustrated in FIG. 7.

<Printer Icon Registrability Determination Processing>

FIG. 8 is a flowchart illustrating an example of the printer icon registrability determination processing, which can be performed by the information processing apparatus 100. In the printer icon registrability determination processing, the information processing apparatus 100 determines whether a printer object and a fax printer object that correspond to the setting target digital multi functional peripheral 101 are registered in the OS. To realize sequential processing in step S701 to step S719, the CPU 200 executes a program of the application 410 loaded into the RAM 201 from the ROM 202 or the external memory 209.

First, in step S701, the printer object management unit 405 requests the OS to transmit a printer object list in response to an instruction received from the main control unit 400. If the OS receives the request from the printer object management unit 405, the OS sends the printer object list indicating printer objects already registered for a user, to the printer object management unit 405. In step S702, if the main control unit 400 receives the printer object list from the printer object management unit 405, the main control unit 400 sets the first printer object in the printer object list as a present confirmation target. In the following processing, the main control unit 400 determines whether a target printer object to be confirmed is a printer object corresponding to the setting target digital multi functional peripheral 101.

Subsequently, instep S703, the main control unit 400 determines whether the IP address of the setting target digital multi functional peripheral 101 coincides with an IP address of the target printer object to be confirmed. In the present exemplary embodiment, the main control unit 400 refers to the IP address of the setting target digital multi functional peripheral 101, which has been held by the setting information management unit 403 in step S605 illustrated in FIG. 7. The main control unit 400 acquires the IP address of the target printer object to be confirmed from the OS via the printer object management unit 405.

In this case, if it is determined that the IP address of the setting target digital multi functional peripheral 101 coincides with the IP address of the target printer object to be confirmed (YES in step S703), the main control unit 400 performs processing instep S704. If it is determined that the IP address of the setting target digital multi functional peripheral 101 does not coincide with the IP address of the target printer object to be confirmed (NO in step S703), the main control unit 400 performs processing in step S715.

In step S704, the main control unit 400 instructs the printer object management unit 405 to perform initialization processing. If the printer object management unit 405 receives the instruction from the main control unit 400, the printer object management unit 405 tries to initialize the target printer object to be confirmed using the printer driver SDK 408.

Subsequently, if success in the initialization processing has been confirmed based on a result acquired via the printer object management unit 405 (YES in step S705), the main control unit 400 performs processing in step S706. More specifically, the main control unit 400 identifies that the target printer object to be confirmed is a printer object that is operable on the application 410.

On the other hand, if failure in the initialization processing has been confirmed (NO in step S705), the main control unit 400 performs processing in step S715. More specifically, the main control unit 400 identifies that the target printer object to be confirmed is a printer object that is limited in a control by the application 410.

In step S706, the main control unit 400 confirms if the target printer object to be confirmed is a fax printer object (if a set driver is a fax driver) using the printer driver SDK 408. In this case, the main control unit 400 refers to a value returned from the printer object management unit 405.

If it is determined that the target printer object to be confirmed is the fax driver (YES in step S707), the main control unit 400 performs processing in step S713. On the other hand, if it is determined that the target printer object to be confirmed is not the fax driver (NO in step S707), the main control unit 400 performs processing in step S708.

In step S708, the main control unit 400 determines whether a port of the target printer object to be confirmed is an application correspondence port that is uniquely used by the application 410. In the present exemplary embodiment, the main control unit 400 acquires port information of the target printer object to be confirmed from the OS via the printer object management unit 405. The main control unit 400 performs the determination processing in step S708 based on the port information acquired from the OS.

In this case, if it is determined that the port of the target printer object to be confirmed is the application correspondence port having been set (YES in step S708), the main control unit 400 performs processing in step S709. On the other hand, if it is determined that the port of the target printer object to be confirmed is not the application correspondence port (NO in step S708), the main control unit 400 performs processing in step S711.

In step S709, the main control unit 400 determines that the target printer object to be confirmed is a registration recommendable (registrable) printer object as a printer icon of the application 410. The main control unit 400 causes the setting information management unit 403 to store determined registrability information.

Subsequently, instep S710, the main control unit 400 causes the setting information management unit 403 to store information indicating that a status display function can be set, as setting information, in the program. Then, the main control unit 400 performs processing in step S715. In the present exemplary embodiment, the status display function is a function usable when the application correspondence port is set. The status display function is usable to acquire and display the status information of the digital multi functional peripheral 101. The information stored as the setting information by the setting information management unit 403 can be read out when the registration of the printer icon is performed and can be reflected as setting default values.

In step S711, the main control unit 400 inquires the setting information management unit 403 and confirms if there is any printer object already determined as a registrable printer object. In this case, if it is determined that there is not any printer object already determined as a registrable printer object (NO in step S711), the main control unit 400 performs processing in step S712.

In step S712, the main control unit 400 sets the target printer object to be confirmed as a registrable printer object candidate, and causes the setting information management unit 403 to store registrability information indicating the registrability of the printer object candidate. Subsequently, the main control unit 400 performs processing in step S715. On the other hand, if it is determined that an already determined printer object is present (YES in step S711), the main control unit 400 performs processing in step S715.

In step S713, the main control unit 400 inquires the setting information management unit 403 and determines whether there is any registrable fax printer object having been already determined. If it is determined that there is not any registrable fax printer object having been already determined (NO in step S713), then in step S714, the main control unit 400 identifies the target printer object to be confirmed as a registrable fax printer object. Subsequently, the main control unit 400 performs processing in step S715. On the other hand, if it is determined that an already determined registrable fax printer object is present (YES in step S713), the main control unit 400 performs processing in step S715.

In step S715, the main control unit 400 inquires the setting information management unit 403 and confirms if both of the printer object determined as a registrable printer object and the printer object determined as a registrable fax printer object are present. In this case, if it is determined that both of the above-described two printer objects are present (YES in step S715), the main control unit 400 terminates the processing of the flowchart illustrated in FIG. 8. If it is determined that at least one of the above-described two printer objects is not determined (NO in step S715), the main control unit 400 performs processing in step S716.

In step S716, the main control unit 400 determines whether there is any printer object that is not yet confirmed in the printer object list. In this case, if it is determined that at least one unconfirmed printer object is present in the printer object list (NO in step S716), then in step S719, the main control unit 400 sets the next printer object in the printer object list as a new confirmation target and restarts the processing in step S703.

On the other hand, if it is determined that all printer objects in the printer object list have been thoroughly confirmed (YES in step S716), the main control unit 400 performs processing in step S717.

In step S717, the main control unit 400 determines whether there is any printer object determined as a registrable printer object candidate. If it is determined that there is not any printer object determined as a registrable printer object candidate (NO in step S717), the main control unit 400 terminates the processing of the flowchart illustrated in FIG. 8. If it is determined that a printer object determined as a registrable printer object candidate is present (YES in step S717), the main control unit 400 performs processing in step S718.

In step S718, the main control unit 400 identifies the printer object candidate as a registrable printer object. Subsequently, the main control unit 400 terminates the processing illustrated in FIG. 8. In this case, for example, if a printer object is determined in step S709 after the printer object candidate is identified, the main control unit 400 prioritizes the determined printer object in determining a registrable printer object over the printer object candidate.

In the present exemplary embodiment, the main control unit 400 causes the setting information management unit 403 to store registrability information indicating the registrability of the identified printer object candidate.

In addition to confirmation of any existing registrable printer object, by executing the above-described processing, the main control unit 400 can select and register an optimum printer object that is suitable for the application 410 in a case where there are a plurality of printer objects whose IP addresses coincide with each other. Further, in a case where both a print-oriented printer object and a fax-oriented fax printer object are present, the main control unit 400 can register both of the printer objects that are different in type by executing the above-described processing.

FIG. 9 is a flowchart illustrating an example of the scan transmission button registrability determination processing, which can be performed by the information processing apparatus 100. In the scan transmission button registrability determination processing, the information processing apparatus 100 determines whether the information processing apparatus 100 can cause the digital multi functional peripheral 101 to register the scan transmission button.

To realize sequential processing to be performed in step S801 to step S813, the CPU 200 executes a program of the application 410 loaded into the RAM 201 from the ROM 202 or the external memory 209. In the registrability determination processing, a web service is an example of the inquiry to the digital multi functional peripheral 101. However, the inquiry to the digital multi functional peripheral 101 is not limited to the web service.

For example, if the digital multi functional peripheral 101 includes a program that can communicate with an external apparatus, the information processing apparatus 100 can inquire the digital multi functional peripheral 101 using an IF that is opened to a third party to perform various inquiries to the program.

In step S801, the main control unit 400 confirms if the main control unit 400 can communicate with the digital multi functional peripheral 101 by designating an IP address. More specifically, the main control unit 400 refers to the IP address of the setting target digital multi functional peripheral 101, which is stored by the setting information management unit 403 in step S605 illustrated in FIG. 7. The main control unit 400 sends the IP address to the scan transmission button management unit 407.

Then, the main control unit 400 instructs the scan transmission button management unit 407 to confirm if the scan transmission button is registrable. If the scan transmission button management unit 407 receives an instruction from the main control unit 400, the scan transmission button management unit 407 transmits a response request packet corresponding to an IP address received from the main control unit 400 via the input management unit 401, and confirms the presence of a response.

In the present exemplary embodiment, the response request packet generated by the information processing apparatus 100 is transmitted, via the network 102, to the digital multi functional peripheral 101. If the digital multi functional peripheral 101 receives the response request packet, the digital multi functional peripheral 101 returns a response packet to the information processing apparatus 100 via the network communication unit 501. The information processing apparatus 100 and the digital multi functional peripheral 101 can communicate with each other via the network 102.

Subsequently, the main control unit 400 receives the response from the digital multi functional peripheral 101 via the input management unit 401 and transmits a notification to the scan transmission button management unit 407 to inform the reception of the response packet.

If the scan transmission button management unit 407 receives the notification from the digital multi functional peripheral 101, more specifically if the response is correctly returned, it is determined that the information processing apparatus 100 can communicate with the digital multi functional peripheral 101 (YES in step S802). In this case, the main control unit 400 performs processing in step S803.

On the other hand, if it is determined that the information processing apparatus 100 cannot communicate with the digital multi functional peripheral 101 due to a communication error or no response within a predetermined time (NO in step S802), the main control unit 400 performs processing in step S813.

In step S803, the scan transmission button management unit 407 instructs the input management unit 401 via the main control unit 400 to transmit an inquiry to the digital multi functional peripheral 101 to confirm if the digital multi functional peripheral 101 opens the scan transmission button registration web service 506 to a third party.

If the network communication unit 501 of the digital multi functional peripheral 101 receives the inquiry about the presence of the opened web service from the information processing apparatus 100, the network communication unit 501 transmits a notification to the main control unit 500 to inform the reception of the inquiry.

In response to reception of the notification, the main control unit 500 requests the web service management unit 504 to confirm if the inquired opened web service is present. In response to the received request, the web service management unit 504 confirms the presence of the scan transmission button registration web service 506 (i.e., one of the web services 505, 506, and 507 that can be managed by the web service management unit 504).

Further, the web service management unit 504 refers to information of the web service 506 if the web service 506 is present and confirms if the web service 506 is opened to a third party. Subsequently, the web service management unit 504 transmits a notification to the main control unit 500 to inform a confirmation result. If the main control unit 500 receives the notification from the web service management unit 504, the main control unit 500 transmits the confirmation result to the information processing apparatus 100 via the network communication unit 501.

Subsequently, if the main control unit 400 receives the confirmation result (response result) from the digital multi functional peripheral 101 via the input management unit 401, the main control unit 400 sends the confirmation result to the scan transmission button management unit 407. If it is determined (recognized) that the scan transmission button registration web service 506 is opened to a third party based on the received confirmation result (YES in step S804), the scan transmission button management unit 407 performs processing in step S805.

On the other hand, if it is determined that the scan transmission button registration web service 506 is not opened to a third party (NO in step S804), the scan transmission button management unit 407 performs processing in step S813. For example, the scan transmission button management unit 407 determines that the scan transmission button registration web service 506 is not opened to a third party when the digital multi functional peripheral 101 is not compatible to the web service or when the web service is not present or not opened to a third party.

In step S805, the scan transmission button management unit 407 instructs, via the main control unit 400, the input management unit 401 to inquire if the digital multi functional peripheral 101 opens the SSO (Single Sign-On) authentication web service 507 to a third party. If the network communication unit 501 of the digital multi functional peripheral 101 receives the above-described inquiry (relating to the presence of the opened web service) from the information processing apparatus 100, the network communication unit 501 transmits a notification to the main control unit 500 to inform the reception of the inquiry.

In response to received notification, the main control unit 500 requests the web service management unit 504 to confirm if the inquired opened web service is present. In response to the received request, the web service management unit 504 confirms the presence of the SSO authentication web service 507 (i.e., one of the web services 505, 506, and 507 that can be managed by the web service management unit 504).

If the web service 507 is present, the web service management unit 504 confirms if the web service 507 is opened to a third party. Further, if the SSO authentication web service 507 is opened to a third party, the web service management unit 504 refers to authentication information (e.g., authentication method and domain information) relating to the web service 507. The web service management unit 504 transmits a notification to the main control unit 500 to inform the presence of the opened web service 507 together with the authentication information. In response to the reception of the notification from the web service management unit 504, the main control unit 500 transmits the response result to the information processing apparatus 100 via the network communication unit 501.

Subsequently, if the main control unit 400 receives the response result from the digital multi functional peripheral 101 via the input management unit 401, the main control unit 400 sends the response result to the scan transmission button management unit 407. If it is determined (recognized) that the SSO authentication web service 507 is opened to a third party based on the received response result (YES in step S806), the scan transmission button management unit 407 performs processing in step S807.

On the other hand, if it is determined that the SSO authentication web service 507 is not opened to a third party (NO in step S806), the scan transmission button management unit 407 performs processing in step S813. For example, the scan transmission button management unit 407 determines that the SSO authentication web service 507 is not opened to a third party when the digital multi functional peripheral 101 is not compatible to the web service or when the web service is not present or not opened to a third party.

In step S807, the scan transmission button management unit 407 determines whether an authentication domain of the information processing apparatus 100 coincides with an authentication domain of the digital multi functional peripheral 101. More specifically, the scan transmission button management unit 407 refers to authentication domain information included in the SSO authentication result received from the digital multi functional peripheral 101 and acquires authentication domain information of the information processing apparatus 100 from the OS. The scan transmission button management unit 407 determines whether the authentication domain of the information processing apparatus 100 coincides with the authentication domain of the digital multi functional peripheral 101.

In this case, if it is determined that the authentication domain of the information processing apparatus 100 coincides with the authentication domain of the digital multi functional peripheral 101 (YES in step S807), the scan transmission button management unit 407 performs processing in step S808.

On the other hand, if it is determined that the authentication domain of the information processing apparatus 100 does not coincide with the authentication domain of the digital multi functional peripheral 101 (NO in step S807), the processing proceeds to step S812. In step S812, the scan transmission button management unit 407 identifies the necessity of entering authentication information in a log-in operation for the digital multi functional peripheral 101. Subsequently, the scan transmission button management unit 407 performs processing in step S811.

In step S808, the scan transmission button management unit 407 acquires authentication information of the authentication domain from the OS. Subsequently, in step S809, the scan transmission button management unit 407 transmits the authentication information to the digital multi functional peripheral 101, via the main control unit 400 and the input management unit 401, based on the authentication domain of the information processing apparatus 100, and logs in the digital multi functional peripheral 101.

Subsequently, if the scan transmission button management unit 407 receives a response of the processing performed in step S809 via the input management unit 401, then in step S810, the scan transmission button management unit 407 requests, via the input management unit 401, the digital multi functional peripheral 101 to transmit scan transmission button setting information. Then, the scan transmission button management unit 407 performs processing in step S811.

If the digital multi functional peripheral 101 receives the request via the network communication unit 501, the digital multi functional peripheral 101 transmits a notification to the main control unit 500 to inform the reception of the request. In response to the received notification, the main control unit 500 causes the web service management unit 504 to acquire scan transmission button setting information of the scan transmission button registration web service 506. Then, the main control unit 500 transmits the acquired scan transmission button setting information to the information processing apparatus 100 via the network communication unit 501.

In the present exemplary embodiment, the scan transmission button setting information includes setting items and their default values required to register the scan transmission button in the digital multi functional peripheral 101. The application 410 can provide an UI (editing UI) that enables users to edit the scan transmission button setting information. If setting information is set by a user via the editing UI and transmitted to the digital multi functional peripheral 101 as information to be used in the registration of the scan transmission button, the scan transmission button is created on the UI of the digital multi functional peripheral 101.

Alternatively, it may also be useful to display the editing UI when cooperative function setting is executed. Further, it may also be useful to set default values beforehand for the cooperative function setting instead of displaying the editing UI and enable users to edit the default values at arbitrary timing.

In step S811, the scan transmission button management unit 407 identifies the scan transmission button as being registrable and transmits a notification to the main control unit 400 to inform the registrability of the scan transmission button. In response to the received notification, the main control unit 400 causes the setting information management unit 403 to store registrability information indicating the registrability of the scan transmission button. Then, the main control unit 400 terminates the processing illustrated in FIG. 9. Further, in addition to the registrability information, the setting information management unit 403 stores the setting information obtained in step S807 (which requires inputting authentication information in a log-in operation), and the scan transmission button setting information acquired in step S810.

In step S813, the scan transmission button management unit 407 identifies the scan transmission button as being unregistrable and transmits a notification to the main control unit 400 to inform the unregistrability of the scan transmission button. In response to the notification from the scan transmission button management unit 407, the main control unit 400 causes the setting information management unit 403 to store registrability information indicating the unregistrability of the scan transmission button. Then, the main control unit 400 terminates the processing illustrated in FIG. 9.

FIG. 10 is a flowchart illustrating an example of the Box function registrability determination processing, which can be performed by the information processing apparatus 100. In the Box function registrability determination processing, the information processing apparatus 100 determines whether the Box function is usable in the digital multi functional peripheral 101. To realize sequential processing to be performed in step S901 to step S906, the CPU 200 executes a program of the application 410 loaded into the RAM 201 from the ROM 202 or the external memory 209.

In step S901, the main control unit 400 accesses the digital multi functional peripheral 101 based on its IP address according to a Universal Naming Convention (UNC) format. More specifically, first, the main control unit 400 refers to the IP address of the setting target digital multi functional peripheral 101 stored in step S605 illustrated in FIG. 7. Then, the main control unit 400 sends the IP address to the document management unit 406 and instructs the document management unit 406 to confirm if the Box function is usable.

In response to the instruction received from the main control unit 400, the document management unit 406 tries to access the digital multi functional peripheral 101 via the input management unit 401 based on the IP address according to the UNC format. The UNC format is a notation usable to designate a resource (e.g., a folder, a file, a shared printer, or a shared folder) accessible via a general network. It becomes feasible to operate an intended folder (or file) by accessing the digital multi functional peripheral 101 according to the UNC format.

Subsequently, in step S902, it is determined whether the document management unit 406 has succeeded in accessing the digital multi functional peripheral 101. More specifically, the network communication unit 501 of the digital multi functional peripheral 101 receives an access request via the network 102 and transmits a notification to the main control unit 500 to inform the reception of the access request.

In response to the received notification, the main control unit 500 reads resource information and transmits the read resource information to the information processing apparatus 100 via the network communication unit 501. Then, the application 410 receives a response from the digital multi functional peripheral 101 via the input management unit 401 and transmits a notification to the document management unit 406 to inform the reception of the response.

The document management unit 406 refers to a returned result included in the received notification. If it is determined that the document management unit 406 has succeeded in accessing the digital multi functional peripheral 101 (YES in step S902), the document management unit 406 performs processing in step S903.

On the other hand, if it is determined that the document management unit 406 has failed in accessing the digital multi functional peripheral 101 (NO in step S902), the document management unit 406 performs processing in step S906. For example, if the returned result includes an error or does not include any response regardless of repetitive accesses performed at predetermined intervals.

In step S903, the document management unit 406 confirms if a subordinate shared folder is present. More specifically, first, the document management unit 406 requests the digital multi functional peripheral 101 (i.e., an access destination) to transmit a folder list. If the network communication unit 501 of the digital multi functional peripheral 101 receives a folder list acquisition request, the network communication unit 501 transmits a notification to the main control unit 500 to inform the reception of the folder list acquisition request.

In response to the received notification, the main control unit 500 instructs the Box function management unit 503 to transmit folder list information managed by the Box function management unit 503. The Box function management unit 503 acquires folder list information stored in the external storage device 314 via the external storage device control unit 313 and transmits the acquired folder list information to the main control unit 500.

If the main control unit 500 receives the folder list information, the main control unit 500 transmits the received folder list information to the information processing apparatus 100 via the network communication unit 501. The application 410 receives the folder list information via the input management unit 401 and sends the received folder list information to the document management unit 406.

Subsequently, in step S904, the document management unit 406 refers to each folder attribute in the received folder list information and determines whether there is any folder that is opened to a third party as a shared folder. In this case, if it is determined that the shared folder is present (YES in step S904), then in step S905, the document management unit 406 determines that the Box function is usable and sends a notification to the main control unit 400 to inform the availability of the Box function. Subsequently, the main control unit 400 terminates the processing illustrated in FIG. 10.

If the main control unit 400 receives the notification from the document management unit 406, the main control unit 400 causes the setting information management unit 403 to store registrability information indicating that the Box function is registrable. Subsequently, the main control unit 400 terminates the processing illustrated in FIG. 10. On the other hand, if it is determined that the shared folder is not present (NO in step S904), the document management unit 406 performs processing in step S906.

In step S906, the document management unit 406 identifies that the Box function is registrable and transmits a notification to the main control unit 400 to inform the registrability of the Box function. If the main control unit 400 receives the notification from the document management unit 406, the main control unit 400 causes the setting information management unit 403 to store registrability information indicating that the Box function is unregistrable. Subsequently, the main control unit 400 terminates the processing illustrated in FIG. 10.

FIG. 11 is a flowchart illustrating an example of miscellaneous cooperative function indication processing, which can be performed by the information processing apparatus 100, according to an exemplary embodiment. The main control unit 400 performs the miscellaneous cooperative function indication processing after the processing illustrated in FIG. 7 is completed and if there is any other cooperative function that can be provided by the digital multi functional peripheral 101 (i.e., the setting target) and the application 410 of the information processing apparatus 100.

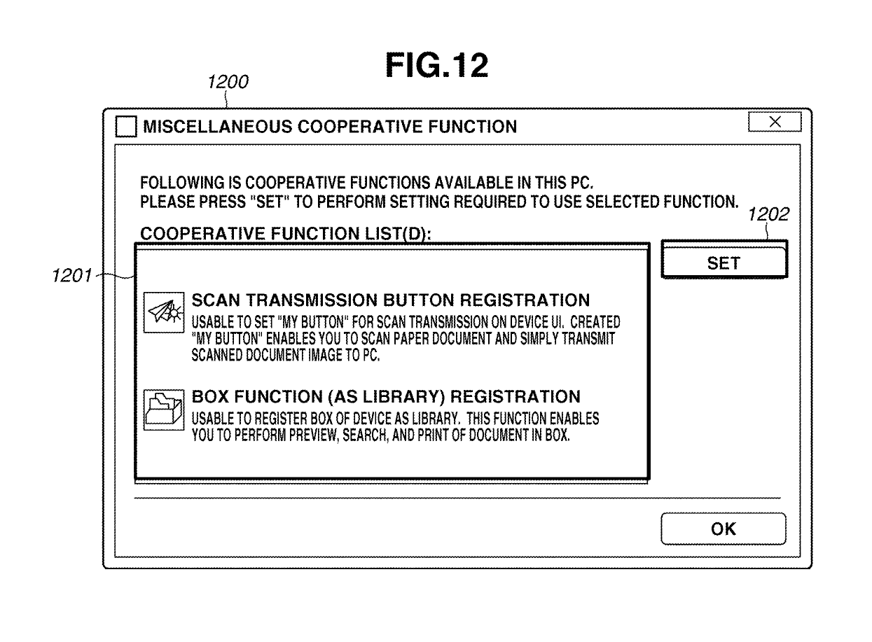

More specifically, in the miscellaneous cooperative function indication processing, if it is determined that there is an item remaining in the miscellaneous cooperative function list as a processing result of the flowchart illustrated in FIG. 7, a miscellaneous cooperative function display screen (e.g., a miscellaneous cooperative function display screen 1200 illustrated in FIG. 12) can be displayed.

Further, the miscellaneous cooperative function display screen receives a user setting reflection execution and reflects the setting if the user executes the setting reflection. The main control unit 400 causes the setting information management unit 403 to store the setting information relating to the application 410.

For example, if setting unique to the application 410 (e.g., a printer icon name or a folder (i.e., a scan transmission destination)) is performed, further, in a case where there is any information required to use an intended function (see step S812), an UI that enables users to input setting information can be displayed. To realize sequential processing to be performed in step S1001 to step S1003, the CPU 200 executes a program of the application 410 loaded into the RAM 201 from the ROM 202 or the external memory 209.

The main control unit 400 starts the present processing after completing the processing illustrated in FIG. 7. In step S1001, the main control unit 400 instructs the setting information management unit 403 to acquire the miscellaneous cooperative function list and confirms if any item is present in the miscellaneous cooperative function list. In this case, if it is determined that there is an item in the miscellaneous cooperative function list (YES in step S1001), the main control unit 400 performs processing in step S1002. On the other hand, if it is determined that there is not any item in the miscellaneous cooperative function list (NO in step S1001), the main control unit 400 terminates the processing illustrated in FIG. 11.

In step S1002, the main control unit 400 sends the item remaining in the miscellaneous cooperative function list to the UI management unit 402 and instructs the UI management unit 402 to display a miscellaneous cooperative function screen. In step S1003, the UI management unit 402 generates a miscellaneous cooperative function screen, in response to a received instruction, based on the list received from the main control unit 400 and displays the generated miscellaneous cooperative function screen on the display device 208. Subsequently, the main control unit 400 terminates the processing illustrated in FIG. 11. The miscellaneous cooperative function display screen displayed on the display device 208 enables users to perform settings.

According to the above-described configuration, the application 410 that provides a cooperative function in cooperation with the digital multi functional peripheral 101 can smoothly start the processing of the cooperative function. Further, displaying the miscellaneous cooperative function screen is useful to enable users to easily confirm the presence (or availability) of an intended cooperative function. The plurality of types of the cooperative functions is not limited to the combination described in the present exemplary embodiment.

### Other Exemplary Embodiment

The embodiments can be realized by executing the following processing. More specifically, example processing includes supplying a software program that can realize the functions described in the above-described exemplary embodiment to a system or an apparatus via a network or using an appropriate storage medium. The processing further includes causing a computer (or a CPU or a micro-processing unit (MPU)) of the system or the apparatus to execute processing based on a readout program. In an example, a computer-readable medium may store a program that causes an information processing apparatus to perform a method described herein. In another example, a central processing unit (CPU) may be configured to control at least one unit utilized in a method or apparatus described herein.

According to the configuration of the above-described exemplary embodiment, the time required to perform cooperative function settings can be reduced.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-110508 filed May 12, 2010, which is hereby incorporated by reference herein in its entirety.

What is claimed is:

1. An information processing apparatus that includes an application capable of providing a plurality of types of cooperative functions in cooperation with a multi functional peripheral, the information processing apparatus comprising:
a setting unit configured to perform setting as a setting processing for each cooperative function of the plurality of types of cooperative functions in response to a user operation via the application;
a determination unit configured to confirm if there is at least one cooperative function that is not yet set by the setting unit and is different from the cooperative function subjected to the setting processing, among the plurality of types of cooperative functions, when the setting unit performs setting for one cooperative function, and, if the at least one cooperative function is confirmed, further configured to determine whether the at least one cooperative function is usable via the application; and
an indicating unit configured to indicate a usable cooperative function determined by the determination unit.

2. The information processing apparatus according to claim 1, wherein
the determination unit is configured to confirm if the at least one cooperative function includes a job control cooperative function that causes the multi functional peripheral to execute a job by transmitting job control information that is required to cause the multi functional peripheral to execute the job,
and if the job control cooperative function is included, further configured to confirm if identification information capable of identifying the multi functional peripheral is already set for an object having a role of the job control cooperative function stored in the information processing apparatus, and
the determination unit is further configured to identify the job control cooperative function of the object, to which the identification information is already set, as a cooperative function usable via the application.

3. The information processing apparatus according to claim 2, wherein
the determination unit is configured to apply an interface whose operation in connection with the application is assured, to the object to which the identification information is already set, and determine whether the application can control the object to which the identification information is already set, and
the determination unit is further configured to identify the job control cooperative function of the object determined as controllable, among job control cooperative functions of the object to which the identification information is already set, as a cooperative function usable via the application.

4. The information processing apparatus according to claim 2, wherein
the determination unit is configured to confirm if the object to which the identification information is already set includes a printer object that transmits job control information required to cause the multi functional peripheral to execute a print job and a fax object that transmits job control information required to cause the multi functional peripheral to execute a fax job, and
the determination unit is further configured to identify a job control cooperative function of the printer object and a job control cooperative function of the fax object as cooperative functions usable via the application.

5. The information processing apparatus according to claim 2, wherein
the determination unit is configured to determine whether information of a port allocated to the object to which the identification information is already set coincides with information of a port uniquely used by the application, and
the determination unit is further configured to identify a job control cooperative function of the object having information of the port uniquely used by the application, among job control cooperative functions of the object to which the identification information is already set, as a cooperative function usable via the application.

6. The information processing apparatus according to claim 5, further comprising:
a control unit configured to enable a function for displaying a status of the multi functional peripheral on a display apparatus when the status is provided by the application via the port, if the determination unit determines that the information of the port allocated to the object to which the identification information is already set coincides with the information of the port uniquely used by the application.

7. The information processing apparatus according to claim 1, wherein
the determination unit is configured to confirm if the at least one cooperative function includes a scan cooperative function that transmits image information scanned by the multi functional peripheral to the information processing apparatus,
and if the scan cooperative function is included, further configured to confirm if the information processing apparatus can communicate with the multi functional peripheral based on identification information capable of identifying the multi functional peripheral, and
the determination unit is further configured to identify the scan cooperative function as a cooperative function usable via the application if a transmission unit having a role of the scan cooperative function is registrable in the multi functional peripheral.

8. The information processing apparatus according to claim 7, wherein the determination unit is configured to determine that the transmission unit is registrable in the multi functional peripheral if it is recognized that the multi functional peripheral opens a service for registering the transmission unit.

9. The information processing apparatus according to claim 8, wherein the determination unit is configured to determine that the transmission unit is registrable in the multi functional peripheral if it is further recognized that an authentication method of the multi functional peripheral corresponds to an authentication to be performed by the information processing apparatus.

10. The information processing apparatus according to claim 1, wherein
the determination unit is configured to confirm if the at least one cooperative function includes an operational cooperative function that operates a folder and a file stored in the multi functional peripheral via the application,
and if the operational cooperative function is included, further configured to confirm if the information processing apparatus can communicate with the multi functional peripheral based on identification information capable of identifying the multi functional peripheral, and
the determination unit is further configured to identify the operational cooperative function as a cooperative function usable via the application if it is confirmed that a folder is opened in the multi functional peripheral.

11. A cooperative function setting control method for execution by an information processing apparatus that includes an application capable of providing a plurality of types of cooperative functions in cooperation with a multi functional peripheral, the cooperative function setting control method comprising:
performing setting as a setting processing for each cooperative function of the plurality of types of cooperative functions in response to a user operation via the application;
confirming if there is at least one cooperative function that is not yet set and is different from the cooperative function subjected to the setting processing, among the plurality of types of cooperative functions, when setting for one cooperative function is performed, and, if the at least one cooperative function is confirmed, further determining whether the at least one cooperative function is usable via the application; and
indicating a determined usable cooperative function.

12. A non-transitory computer readable storage medium storing a program that causes a computer including an application capable of providing a plurality of types of cooperative functions in cooperation with a multi functional peripheral to function as:
a setting unit configured to perform setting as a setting processing for each cooperative function of the plurality of types of cooperative functions in response to a user operation via the application;
a determination unit configured to confirm if there is at least one cooperative function that is not yet set by the setting unit and is different from the cooperative function subjected to the setting processing, among the plurality of types of cooperative functions, when the setting unit performs setting for one cooperative function, and, if the at least one cooperative function is confirmed, further configured to determine whether the at least one cooperative function is usable via the application; and
an indicating unit configured to indicate a usable cooperative function determined by the determination unit.
